(19) United States
(12) Patent Application Publication
(10) Pub. No.: US 2003/0116569 A1
(43) Pub. Date: Jun. 26, 2003

(54) Container for storing hospital and agri-food industry waste

(76) Inventor: Joel Mercier, La Colle Sur Loup (FR)

Correspondence Address: DENNISON, SCHULTZ & DOUGHERTY, 1745 JEFFERSON DAVIS HIGHWAY, ARLINGTON, VA, 22202, US

(21) Appl. No.: 10/239,864

(22) PCT Filed: Apr. 13, 2001
(86) PCT No.: PCT/FR01/01152

(30) Foreign Application Priority Data
Apr. 13, 2000 (FR) 00/04749

(51) Int. Cl. B65F 1/00; B65D 51/04; B65D 43/14

(52) U.S. Cl. 220/259.2; 220/825; 220/826; 220/908

(57) ABSTRACT

A container for storing waste, in particular hospital waste and food industry waste, the container presents a receptacle closed by a top element in which an opening is formed. The container comprises: a cover (10) having at least one hole (24, 26); at least one stud (24a, 26a) having a free end presenting fastening means (24c, 26c), said stud (24a, 26a) being in register with said hole (24, 26), enabling it to pass through said hole (24, 26) when said cover (10) is in a closed position on said opening (12); and non-return blocking means (24b, 26b) that are fixable to said fastening means (24c, 26c) (12) of said element.

The present invention relates to a container storing waste, in particular hospital waste, the container being constituted by a receptacle closed by a top element having an opening formed therein.

Receptacles or trash cans are known for storing waste, and in particular for storing hospital waste.

Such cans are generally placed on the ground and have a top opening with a cover hinged to the edge thereof, the cover being openable under the control of a pedal fixed to the bottom of the can. In order to comply with hygiene rules, a plastic bag is pressed against the inside wall of the can and waste is put into the bag so that once the can is full, all of the waste can be removed therefrom without any risk of dirtying the environment in which the bag is handled. Thereafter such bags are incinerated so as to destroy all contaminants completely.

Nevertheless, plastic bags have thin walls that can be perforated by an object contained inside the bag, for example a syringe which might be dirty and represents potential danger for operatives handling the bags.

In addition, with a can of the type in which a plastic bag is fitted so that its walls are folded down over the edge of the opening with the cover then being pressed down onto the walls of the bag, there is a risk of the can being tipped over since it merely stands on the ground. Since the cover is not locked to the body of the can, the waste contained therein can be spread about.

Given the contamination that might arise from dirty objects or substances, in particular in hospitals, attempts have been made to render the receptacles of that type of trash can more reliable.

An object of the present invention is to provide a rigid container for storing and transporting waste, said container having a cover which is not liable to open in untimely manner, thus ensuring that the waste it contains is retained inside it.

According to the invention, this object is achieved by a container for storing waste, in particular hospital waste, the container presenting a receptacle closed by a top element having an opening formed therein, and being characterized in that it comprises:

a cover hinged to the edge of said opening by means of a hinge, the cover having a closed position in which a first portion thereof closes said opening and a second portion thereof presses against the outside wall of said top element in the surround of said opening, said second portion having at least one hole in a portion that is substantially opposite from said hinge;

at least one stud having a free end presenting fastening means, the stud being secured to the outside wall of said top element in the surround of said opening to face said hole such that said stud passes through said hole when said cover is in its closed position on said opening; and

non-return blocking means fixable to said fastening means and of dimensions greater than the dimensions of said hole so that said non-return blocking means press against at least a fraction of the outer wall portion of said cover in the vicinity of said stud so as to hold said cover against the outside wall of said top element, thereby causing said cover to be held in irreversible manner against the opening of said element.

Thus, a characteristic of the container lies in the way in which its opening is definitively closed so as to isolate the content of said container from the outside environment throughout the stage that follows filling, i.e. transport and until complete destruction of the waste.

In addition to the normal function of a cover hinged to the edge of an opening by means of a hinge, namely the function of closing said opening on a temporary basis, said cover is suitable for being blocked in quasi-irreversible manner on the opening. It will be understood that the cover which is of dimensions greater than those of the opening has a first portion that covers the opening completely and a second portion corresponding to the periphery of the first portion that presses against the surround of the opening. The cover fixing means are situated in the surround of the opening and in the second portion.

It will be understood that the stud fixed in the surround of the opening extending perpendicularly to the wall thereof passes through the hole formed in the second portion facing the stud when the cover is closed on the opening.

The fastening means at the free end of the stud cooperate with the non-return blocking means so that the engagement of these means on the fastening means is irreversible. Thus, when the container is full and it is desired to dispose of the waste, the cover is closed and the non-return blocking means are fixed onto the free end of the stud so as to clamp the cover between the wall on which the stud is fixed and the blocking means which press against the periphery of the hole in the outside wall of the cover.

It will also be understood that said hole and the fixing means associated therewith, both situated in a portion that is substantially opposite from the hinge, co-operate with the hinge to constitute two diametrically opposite points for fixing the cover.

According to an advantageous, second characteristic of the invention, the top element further comprises, in register with said opening formed in said container, a flap-forming member that opens elastically towards the inside of said receptacle so as to enable waste to be introduced therein and so as to close said opening when in the rest position, whereby waste introduced into said container cannot escape from said container through said opening.

Thus, when waste is inserted into the container, the flap-forming member is moved inwards so as to release an opening through which the waste can pass. Once the waste has passed through the opening, the flap-forming member hinged resiliently to the edge of the opening returns to its initial position and presses against the inside edges of the opening so as to close it. This characteristic makes it possible to ensure that waste does not leave the container while it is being handled.

A preferred third characteristic of the container lies in the fact that the top element and said receptacle further comprise self-blocking means for fixing said top element on said receptacle in irreversible manner.

It will be understood that the top element and the container are made separately and that assembly thereof must necessarily be practically irreversible in order to ensure closure with a good level of security. Thus, the top element and the container present self-blocking means suitable for co-operating to implement quasi-irreversible closure of said container by means of said top element.

According to an advantageous fourth characteristic, said cover is extended in its portion remote from the hinge by a tongue suitable for co-operating in reversible manner with a moving clasp secured to said top element so as to clamp against said tongue when the cover is in its closed position, thereby holding said cover in the closed position.

This characteristic enables the container to be kept closed while it is being filled. The container is filled by degrees as waste is produced, so filling operations can be spread out over time. Between stages of incorporating waste it is necessary to keep the cover closed for greater security, and the cover is held in this position by the moving clasp which is engaged on said tongue.

Advantageously, said fastening means form a shoulder whose bearing face faces the outside wall of said element, said fastening means being elastically compressible in a lateral direction. Thus, the fastening means are suitable for co-operating preferentially with the non-return blocking means constituted by a ring whose outside diameter is greater than the size of said hole and whose inside diameter is substantially smaller than the width of said shoulder, whereby said ring is engaged under pressure entirely on said free end of said stud so that the top edge of said ring comes into abutment against said shoulder.

It will be understood that the ring is engaged by force onto the fastening means since its inside diameter is smaller than the width of the shoulder and that the fastening means are compressed and then return to their initial state once the top portion of said ring has been engaged beyond the shoulder.

Advantageously, said cover, said stud, and said blocking means are made of elastically deformable plastics material. Thus, the fastening means can be deformed elastically for fixing the blocking means which themselves deform elastically.

In a preferred embodiment, said cover is hinged to the edge of a bushing suitable for being engaged by force in said opening, and said stud is fixed on said bushing in such a manner that said cover, said hinge, said bushing, and said stud are molded as a single piece.

Thus, the closure device is made by means of a single recess formed in a mold, enabling assembly of the container to be simplified considerably.

In another preferred embodiment, the non-return blocking means are connected to said bushing and are integrally molded with said cover, said hinge, said bushing, and said stud.

The blocking means are connected to the bushing by an arm of plastics material integrally molded with the assembly and presenting small wall thickness so as to enable said blocking means to be hinged freely relative to the bushing in such a manner as to fix them to the fastening means.

In yet another preferred implementation, the moving clasp is secured to said bushing and is integrally molded with said tongue, said cover, said hinge, said bushing, said stud, and said non-return blocking means.

Other features and advantages of the invention appear on reading the following description of particular embodiments of the invention, given as non-limiting indications and made with reference to the accompanying drawings, in which:

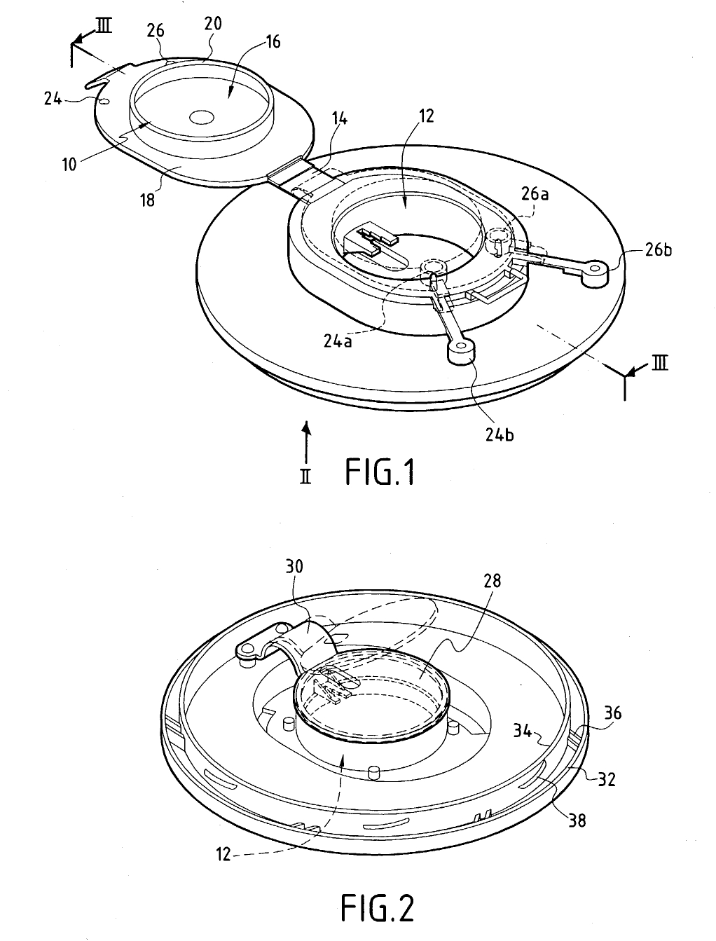

FIG. 1 is a perspective view seen from above of a top element in which the cover is in an open position;

FIG. 2 is a perspective view from below of a top element showing the flap;

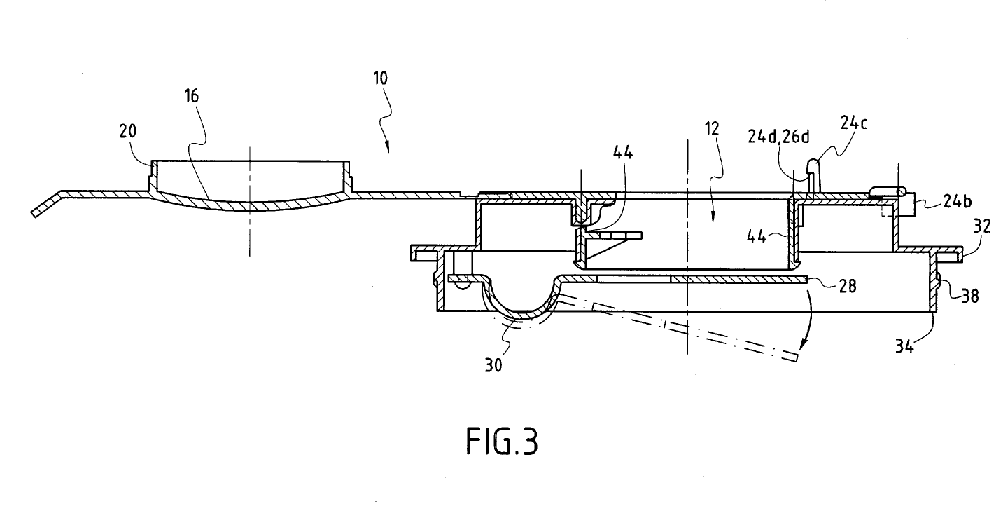

FIG. 3 is a section view on III-III of FIG. 1;

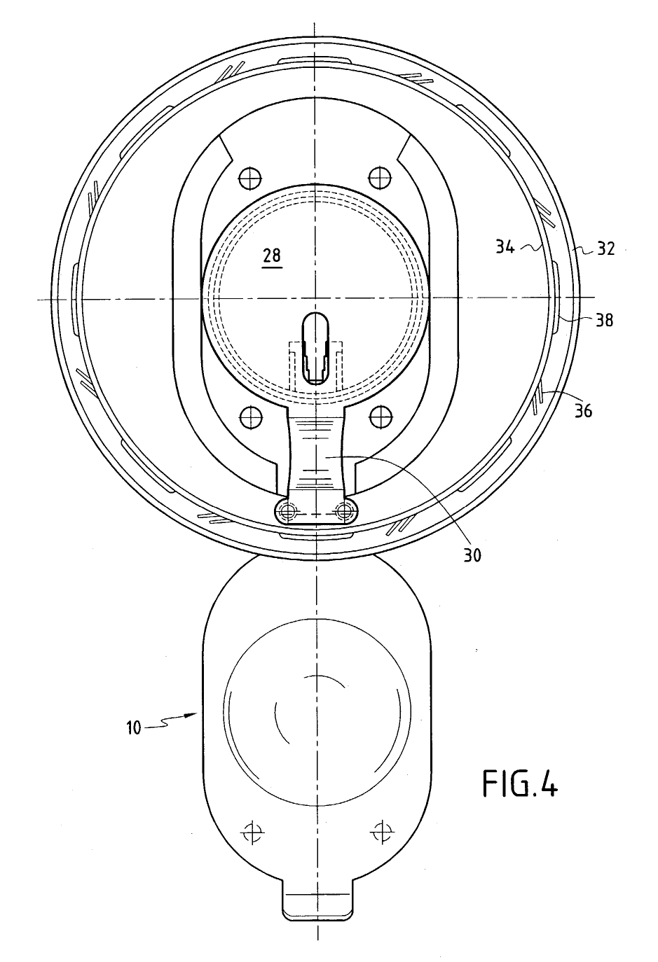

FIG. 4 is an elevation view from above showing a top element with its cover in the open position; and

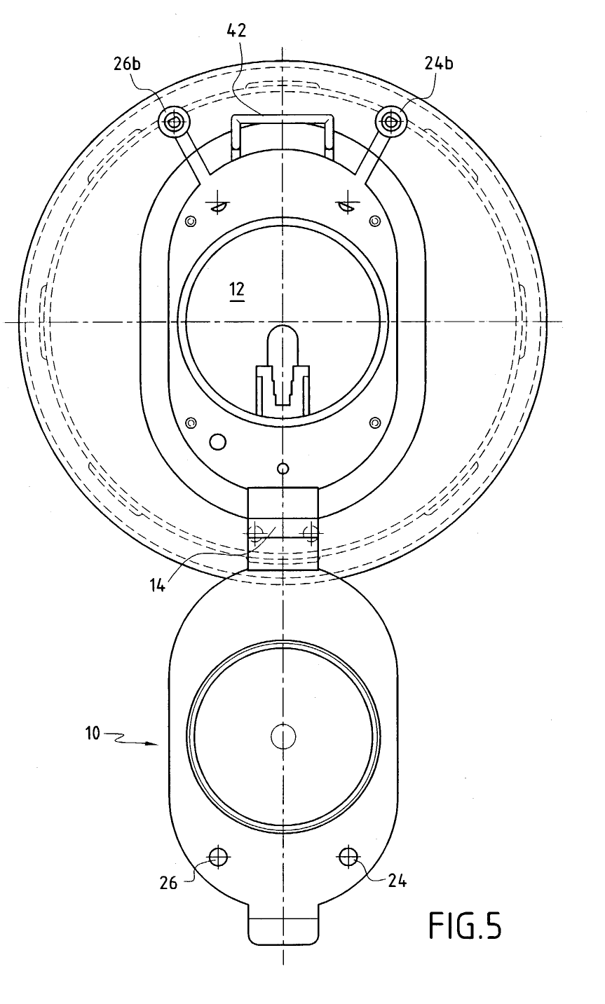

FIG. 5 is an elevation view from below showing a top element with its cover in the open position.

A top element suitable for closing a receptacle is described, initially with reference to FIGS. 1 and 2.

The top element comprises a cover 10 suitable for closing an opening 12. The cover 10 is connected to the edge of the opening 12 by a hinge 14. The cover 10 has a first portion 16 and a second portion 18 situated around the first portion 16, the boundary between the two portions 16 and 18 being defined by a ring 20 suitable for being received exactly in the periphery of the opening 12 so as to provide good sealing on closure. When the cover 10 is folded down onto the opening 12, the second portion 18 comes to bear against the outside wall 22 of the top element all around the surround of the opening 12, and the first portion closes said opening completely.

The cover 10 has two holes 24 and 26 suitable for co-operating with two studs 24a and 26a so that the two studs 24a and 26a pass through the holes 24 and 26 respectively when the cover is in the closed position. At their free ends, each of the two studs has respective fastening means 24c and 26c.

The top element also has non-return blocking means 24b and 26b hinged on said element in such a manner as to be fixable to the free ends of the studs 24a and 26a respectively. Naturally, the non-return blocking means 24b and 26b are fixed only once the cover 10 has been folded down, thereby locking closure.

With reference to FIG. 2, the top element can be seen from beneath. It has a flap-forming member 28 connected to the inside wall of said top element by a flexible hinge 30 holding the member resiliently against the inside edge of the opening 12. Thus, the member closes the opening 12 while in its rest position, and it releases said opening once force is exerted on the member 28 from the outside wall of the top element. As soon as external force ceases to be applied to the member 28, the flexible hinge 30 returns to its initial shape and the member 28 returns to its initial position.

FIG. 3 shows the top element of FIG. 1 in section on III-III, and there can be seen the flap-forming member 28 and the flexible hinge 30. It will be understood that the opening 12 is closed by the member 28 pressing against the inside wall of the top element.

In practice, the hinge 30 and the flap-forming element 28 form a single piece which is fixed to the inside wall of the top element.

The self-blocking means for fixing the top element in irreversible manner on a receptacle (not shown) are described below with reference to FIG. 4 and also to FIG. 2.

The edge of the top element has a first rim 32 and a second rim 34 parallel to the first and inside the inside wall of the top element. The first rim 32 has a smooth inside wall which is pressed against the outside wall of the receptacle. The second rim has pairs of studs 36 and longitudinal ribs 38 on its wall facing the first rim 32, and distributed all around the periphery of said rim.

The studs 36 are inclined at a constant angle relative to the tangents of the mean circle constituted by a line passing through the middle of the wall of the second rim 34 facing the first rim, and all around the periphery of the top element. The free ends of the studs 36 lie at a determined distance from the inside wall of the first rim 32. These studs co-operate with the inside wall of the receptacle, which inside wall is crenellated so as to constitute rotary non-return means, i.e. the top element can turn relative to the receptacle in one direction only.

The ribs 38 are disposed on the wall of the second rim between two pairs of studs 36 and they are inclined at a constant angle relative to the mean plane defined by the mean circle. These ribs co-operate with studs fixed on the edge of the inside wall of the receptacle so as to block the top element on the receptacle. The element is engaged on the receptacle in such a manner that the ribs 38 lie between the studs, and then the top element is turned so that the ribs engage under the studs. Given the slope of the ribs, turning the top element causes it to be pushed down until the edge of the receptacle comes into abutment against the inside wall of the top element. In addition, the non-return means prevent the top element from turning in the opposite direction, so the top element becomes blocked in position on the receptacle.

The means for holding the cover in its closed position in temporary manner are described below with reference to FIG. 5.

To do this, the cover 10 has an extension 40 or “tongue” projecting from its portion remote from the hinge, and suitable for co-operating with a moving clasp 42 secured to the top element. Thus, during times when the container is to be kept closed temporarily, the cover 10 is closed down onto the opening 12 and the clasp 42 is engaged on the tongue 40 so as to hold it. The clasp 42 is held in position by the tongue 40 which is elastically deformable at its end, which end needs to be deformed in order to engage the clasp 42, and on returning to its initial shape prevents the clasp from disengaging.

The fastening means 24c and 26c co-operating with the non-return blocking means 24b and 26b are described with reference to FIGS. 3 and 5.

In FIG. 3, the fastening means 24c and 26c form shoulders having bearing faces 24d and 26d facing the outside wall 22 of the top element. The free ends of the studs 24a and 26a are elastically compressible so that the non-return blocking means 24b and 26b shown in FIG. 6 form a ring of inside diameter that is substantially smaller than the diameter of the shoulder-forming free ends of the studs, which rings can be engaged by force on the studs.

When the top edge of the ring is engaged beyond the shoulder, then the end returns to its initial shape such that the bearing face 24d or 26d of the shoulder constitutes a stop point for the top edge of the ring preventing it from being disengaged from the stud 24 or 26.

It will be understood that a simple way of constituting the elastically-deformable elements is to make them out of a suitable plastics material having a relatively high coefficient of elasticity.

In addition, it is also possible to make a set of parts suitable for constituting all of the above-described functions as a single piece by molding a single piece of plastics material.

Thus, with reference to FIG. 3, in order to make a maximum number of elements as a single piece, the cover 10 is hinged by means of a hinge to the edge of a bushing 44 which is engaged by force in the opening 12: the studs 24 and 26 are fixed to said bushing 44, the non-return blocking means 24b and 26b are connected to the bushing 44 by tabs, the clasp 42 is also connected to the bushing 44, and the tongue 40 extends the cover 10. In this way, all of the above elements are molded as a single piece of plastics material.

In a particular embodiment (not shown), the flap-forming member is constituted by a plurality of flexible blades suitable for closing the opening of said top element. The blades are preferably elastically flexible and suitable for being moved away from the opening by being moved towards the inside of the receptacle.

1. A container for storing waste, in particular hospital waste or food industry waste, the container presenting a receptacle closed by a top element having an opening formed therein, and being characterized in that it comprises:
a cover (10) hinged to the edge of said opening (12) by means of a hinge (14), the cover having a closed position in which a first portion (16) thereof closes said opening and a second portion (18) thereof presses against the outside wall (22) of said top element in the surround of said opening (12), said second portion (18) having at least one hole (24, 26) in a portion that is substantially opposite from said hinge (14);
at least one stud (24a, 26a) having a free end presenting fastening means (24c, 26c), the stud being secured to the outside wall (22) of said top element in the surround of said opening (12) to face said hole (24, 26) such that said stud (24a, 26a) passes through said hole (24, 26) when said cover (10) is in its closed position on said opening (12); and
non-return blocking means (24b, 26b) fixable to said fastening means (24c, 26c) and of dimensions greater than the dimensions of said hole (24, 26) so that said non-return blocking means (24b, 26b) press against at least a fraction of the outer wall portion of said cover (10) in the vicinity of said stud (24a, 26a) so as to hold said cover (10) against the outside wall (22) of said top element, thereby causing said cover (10) to be held in irreversible manner against the opening (12) of said element.

2. A container for storing waste according to claim 1, characterized in that said top element further comprises, in register with said opening (12) formed in said container, a flap-forming member (28) that opens elastically towards the inside of said receptacle so as to enable waste to be introduced therein and so as to close said opening (12) when in the rest position, whereby waste introduced into said container cannot escape from said container through said opening (12).

3. A container for storing waste according to claim 1 or claim 2, characterized in that said top element and said receptacle further comprise self-blocking means (32, 34, 36, 38) for fixing said top element on said receptacle in irreversible manner.

4. A container for storing waste according to any one of claims 1 to 3, characterized in that said cover (10) is extended in its portion remote from the hinge (14) by a tongue (40) suitable for co-operating in reversible manner with a moving clasp (42) secured to said top element so as to clamp against said tongue (40) when the cover (10) is in its closed position, thereby holding said cover (10) in the closed position.

5. A container for storing waste according to any one of claims 1 to 4, characterized in that said fastening means (24c, 26c) form a shoulder whose bearing face (24d, 26d) faces the outside wall (22) of said element, said fastening means (24c, 26c) being elastically compressible in a lateral direction.

6. A container for storing waste according to any one of claims 1 to 5, characterized in that the non-return blocking means (24b, 26b) are constituted by a ring of outside diameter greater than the size of said hole (24, 26) and of inside diameter substantially smaller than the width of said shoulder whereby said ring is engaged by pressure fully onto said free end of said stud so that the top edge of said ring comes into abutment against said shoulder.

7. A container for storing waste according to any one of claims 1 to 6, characterized in that said cover (10), said stud (24a, 26a), and said blocking means (24b, 26b) are made of elastically deformable plastics material.

8. A container for storing waste according to any one of claims 1 to 7, characterized in that said cover (10) is hinged to the edge of a bushing (44) suitable for being engaged by force in said opening (12), and in that said stud (24a, 26a) is fixed on said bushing (44) in such a manner that said cover (10), said hinge (14), said bushing (44), and said stud (24a, 26a) are molded as a single piece.

9. A container for storing waste according to claim 8, characterized in that said non-return blocking means (24b, 26b) are connected to said bushing (44) and are integrally molded with said cover (10), said hinge (14), said bushing (44), and said stud (24a, 26a).

10. A container for storing waste according to claim 4 and 8 or 9, characterized in that said moving clasp (42) is secured to said bushing (44) and is integrally molded with said tongue (40), said cover (10), said hinge (14), said bushing (44), said stud (24a, 26a), and said non-return blocking means (24b, 26b).
